(19) United States
(12) Patent Application Publication
(10) Pub. No.: US 2003/0226062 A1
(43) Pub. Date: Dec. 4, 2003

(54) System and method for testing response to asynchronous system errors

(76) Inventors: Thomas K. Gender, Glendale, AZ (US); James Chow, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/161,455

(22) Filed: Jun. 3, 2002

(51) Int. Cl. H04B 1/74

(52) U.S. Cl. 714/38

(57) ABSTRACT

An error response test system and method with increased functionality and improved performance is provided. The error response test system provides the ability to inject errors into the application under test to test the error response of the application under test in an automated and efficient manner. The error response test system injects asynchronous errors into the application under test by inserting code sequences of application code that are desired to create an error in the application under test. The error response test system inserts the error creation code directly into the object of the application under test. The inserted error creation code causes an error in the application under test at the specific point of insertion. The error creation code is designed to implement asynchronous errors that cannot normally be tested. Furthermore, the error creation code can be inserted in any location in the application under test. Thus, the application under test can be thoroughly tested for asynchronous error response.

### STATEMENT OF GOVERNMENT INTEREST

The U.S. Government has a paid-up license in this invention and the right in limited circumstances to require the patent owner to license to others on reasonable terms as provided for by the terms of Contract No. NAS15-10000 awarded by the National Aeronautics and Space Administration (NASA), Boeing Subcontract No. 940S9001.

### BACKGROUND OF THE INVENTION

1. Technical Field

This invention generally relates to computer systems, and more specifically relates to testing of computer systems.

2. Background Art

Modern life is becoming more dependent upon computers. Computers have evolved into extremely sophisticated devices, and may be found in many different applications. These applications involve everything from application specific computers found in everyday devices such as automobiles, phones and other electronics, to the general purpose computers found in the form of PDAs, personal computers, servers and mainframes.

As computers become more integrated into daily life, their reliability becomes a greater and greater necessity. In order to ensure sufficient reliability it is necessary to thoroughly test computer systems. Thorough testing involves testing both the hardware and software of the computing system to ensure that the system operates properly in a wide range of situations.

One of the more difficult areas in computer system performance to test is the computer system's response to errors in operation. The major difficulty in testing a computer's response to asynchronous errors is in steps that need to be taken to inject the errors into the system. Typically, this has been accomplished with intrusive methods.

For example, a debugger or emulator is used to set breakpoints into the software at which the errors are injected by operator command. These methods are tedious, time consuming and not easily automated. Another method is to instrument the source code to cause the error. This involves the creation of a special version of the software that is hard coded to cause the error. This approach raises several issues. The first being that multiple versions of the software must be maintained. The second issue is that the software being tested is no longer the actual operational software, and the actual operational software may in fact respond differently then the test software.

For these reasons, the computer system's response to asynchronous errors may not be tested fully. Instead, only a few manual tests may be performed, and they may not be repeated as the application is modified in the future. Or in some cases, the failure conditions may not be tested at all.

Thus, what is needed is an improved testing system and method that provides for more complete testing of a computer system's response to asynchronous errors.

### DISCLOSURE OF INVENTION

The present invention provides an error response test system and method with increased functionality and improved performance. The error response test system provides the ability to inject asynchronous errors into the application under test to test the error response of the application under test in an automated and efficient manner.

The error response test system injects asynchronous errors into the application under test by inserting code sequences of application object code that are desired to create an error in the application under test. The error response test system inserts the error creation code directly into the object code of the application under test. The inserted error creation code causes an error in the application under test at the specific point of insertion. The error creation code is designed to implement asynchronous errors that cannot normally be tested. Furthermore, the error creation code can be inserted in any location in the application under test. Thus, the application under test can be thoroughly tested for error response.

The error response system thus provides increased testing flexibility and functionality, allowing computer systems to be fully tested to improve the reliability of the computer system. Furthermore, the error response system and method facilitates the testing of asynchronous errors that cannot normally be tested.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of a computer system;

FIG. 2 is a schematic view of a error response test system;

FIG. 3 is a table illustrating types of asynchronous errors that can be emulated and exemplary error creation code sequences;

FIG. 4 is flow diagram of a method for testing the error response of an application; and

FIG. 5 is a schematic view of application code sequences before and after insertion of error creation code sequences.

### BEST MODE FOR CARRYING OUT THE INVENTION

The present invention provides an error response test system and method with increased functionality and improved performance. The error response test system provides the ability to inject asynchronous errors into the application under test to test the error response of the application under test in an automated and efficient manner.

The error response test system injects errors into the application under test by inserting code sequences of application code that are desired to create an error in the application under test. The error response test system inserts the error creation code directly into the object code of the application under test. The inserted error creation code causes an error in the application under test at the specific point of insertion. The error creation code can be designed to implement asynchronous errors that cannot normally be tested. Furthermore, the error creation code can be inserted in any location in the application under test. Thus, the application under test can be thoroughly tested for error response.

The error response test system is particularly applicable to the testing of how an application program responds to asynchronous errors. An asynchronous error is a type of system error that can occur at virtually any time and at any place during operation of the application. It differs from a synchronous error, which can only occur in response to a specific action taken by the application. Asynchronous errors are typically quite rare and are generally of such a serious nature that the application must alter its current control flow and enter a recovery state that restricts system operation. Asynchronous errors normally become apparent to the application via an interrupt. Because of the nature of asynchronous errors, applications are rarely tested for their handling of these errors. Because the test system allows these errors to be efficiently tested, the reliability of the application software can be improved.

The error response test system supports the testing of an application program's response to asynchronous errors at various program execution states. In particular, because the error creation code can be inserted throughout the application program, each area of the application program can be tested. Thus, the application under test can be tested for response to asynchronous errors that occur at system initialization and startup, as well during normal operation.

The error response test system has the distinct advantage over prior solutions in that it does not require the modification of the application's source code. This removes the need to keep multiple versions of the source code, and assures that the code being tested is the actual code that will be used. This again provides advantages for testing efficiency and reliability.

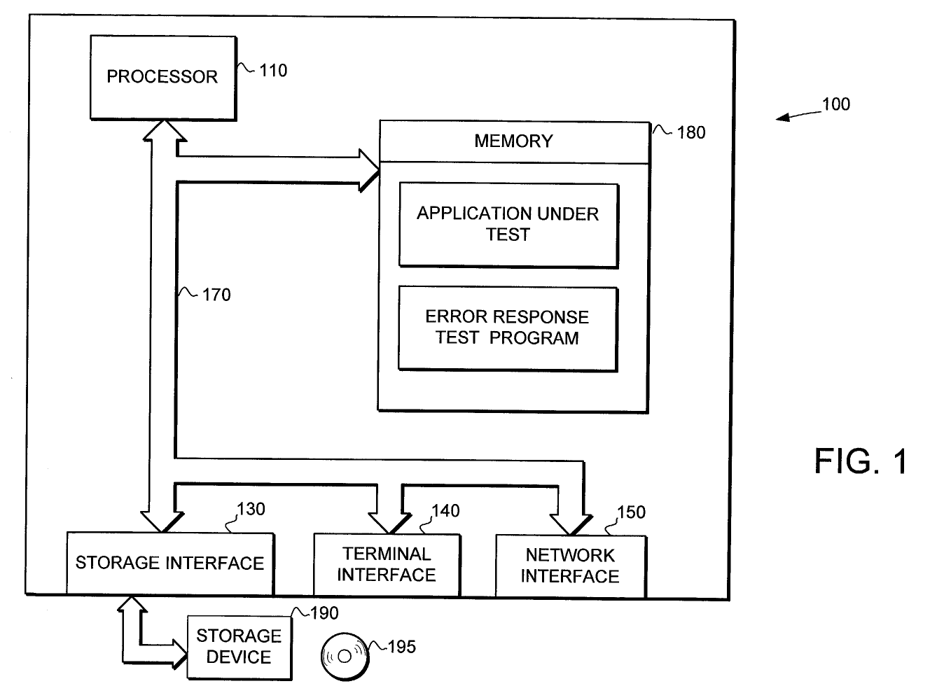

Turning now to FIG. 1, an exemplary computer system 100 is illustrated. Computer system 100 illustrates the general features of a computer system that can be used to implement the invention. Of course, these features are merely exemplary, and it should be understood that the invention can be implemented using different types of hardware that can include more or different features. The exemplary computer system 100 includes a processor 110, a storage interface 130, a terminal interface 140, a network interface 150, a storage device 190, a bus 170 and a memory 180. In accordance with the preferred embodiments of the invention, the memory system 100 includes an application under test and an error response test program.

The processor 110 performs the computation and control functions of the system 100. The processor 110 may comprise any type of processor, include single integrated circuits such as a microprocessor, or may comprise any suitable number of integrated circuit devices and/or circuit boards working in cooperation to accomplish the functions of a processing unit. In addition, processor 110 may comprise multiple processors implemented on separate computer systems, such as a system where a first processor resides on a target computer system designed to closely resemble the final hardware system and a second processor resides on a test computer system coupled to the target hardware system for testing. During operation, the processor 110 executes the programs contained within memory 180 and as, controls the general operation of the computer system 100.

Memory 180 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 180 may be a single type of memory component, or it may be composed of many different types of memory components. In addition, the memory 180 and the processor 110 may be distributed across several different computers that collectively comprise system 100. For example, a portion of memory 180 may reside on the target hardware system and another portion may reside on the test system.

The bus 170 serves to transmit programs, data, status and other information or signals between the various components of system 100. The bus 170 can be any suitable physical or logical means of connecting computer systems and components. This includes, but is not limited to, direct hard-wired connections, fiber optics, infrared and wireless bus technologies.

The terminal interface 140 allows users to communicate with system 100, and can be implemented using any suitable method and apparatus. The network interface 150 allows the computer system 100 to communicate with other systems, and can be implemented using any suitable method and apparatus. The storage interface 130 represents any method of interfacing a storage apparatus to a computer system. Storage device 190 can be any suitable type of storage apparatus, including direct access storage devices such as hard disk drives, floppy disk drives and optical disk drives. As shown in FIG. 1, storage device 190 can comprise a CD type device that uses optical discs 195 to store data.

In accordance with the preferred embodiments of the invention, the memory system 100 includes an application under test and an error response test program. During operation, the application under test and the error response test program are stored in memory 180 and executed by processor 110. The error response test program injects errors into the application under test by inserting code sequences of application code that are desired to create an error in the application under test. The error response test system inserts the error creation code directly into the object of the application under test. The inserted error creation code causes an error in the application under test at the specific point of insertion. Thus, the error response test program can monitor and evaluate the response of the application program to the error, and the application under test can be thoroughly tested for error response. It should be noted that this testing is not designed to test the original code sequence that is modified by the error response test program. Instead, it is designed to test the response of the application under test to an asynchronous error that occurs at this location.

It should again be noted that the preferred implementation of the computer system would typically have the application under test residing on a target computer system that models the production computer system. This provides the most effective test bed for the application under test. The error response test program would typically be located on a separate computer system coupled to the target computer system to allow the error response test program to control and/or monitor the test. Furthermore, in many common applications the target computer system would comprise an embedded system designed as a combination of hardware and software that are integrated together as part of a larger overall system.

It should be understood that while the present invention is described in the context of a fully functioning computer system, those skilled in the art will recognize that the mechanisms of the present invention are capable of being distributed as a program product in a variety of forms, and that the present invention applies equally regardless of the particular type of signal bearing media used to carry out the distribution. Examples of signal bearing media include: recordable media such as floppy disks, hard drives, memory cards and optical disks (e.g., disk 195), and transmission media such as digital and analog communication links, including wireless communication links.

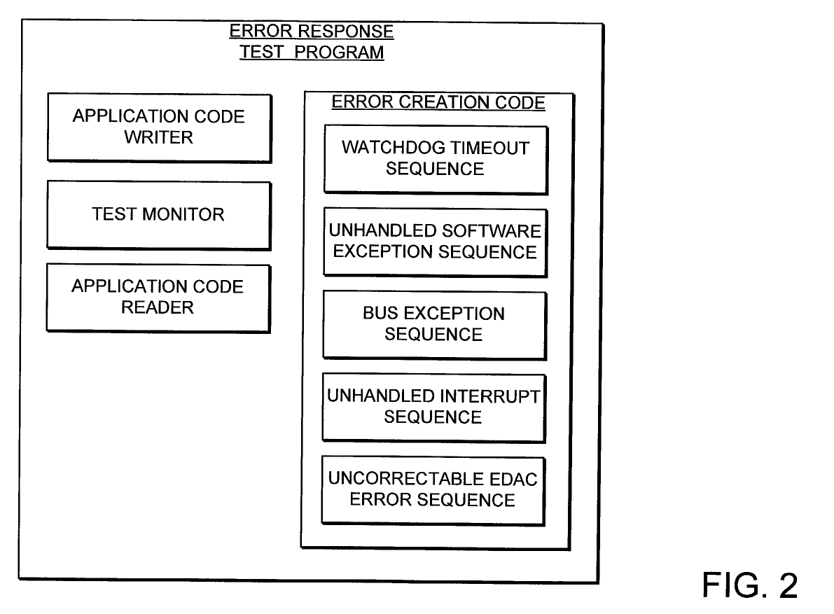

Turning now to FIG. 2, the error response test program is illustrated schematically, with the main elements of the program illustrated individually. In the illustrated embodiment, the error response test program includes an application code reader, an application code writer, a test monitor, and a plurality of error creation code sequences.

The application code writer allows the error response test program to modify the application under test. Specifically, the application code writer facilitates the replacement of object code sequences in the application under test with asynchronous error creation code sequences that have been designed to generate specific types of errors in the application. The application code writer provides the ability for the error response test system to write the memory in which the software application executes. This functionality is often found in systems that support the real-time reloading of its software or allow special access to internal memory for diagnostic purposes.

The test monitor forces a run through the modified application code while monitoring the application's response to the resulting error. This functionality is commonly found in many different test driver applications, and can be implemented with any suitable testing mechanism.

The application code reader allows the test program to copy elements of the application program, allowing them to be saved before they are modified for testing. This allows the error response test program to return the application under test to its unmodified condition, facilitating further testing of the program. In some cases it will not be necessary or desirable to include a code reader, and in those circumstances the modified application object code can be left in the modified state until testing is complete, and then discarded.

The error creation code provides the sequences that have been designed to produce specific errors in the application when they are inserted and executed. In accordance with the preferred embodiment, several different types of error creation code are provided. Each different type of code sequence produces a different type of asynchronous error when inserted into the application code. In the illustrated embodiment, the error creation code includes a watchdog timeout sequence, an unhandled software exception sequence, a bus exception sequence, an unhandled interrupt sequence, and an uncorrectable EDAC error sequence. These sequences are designed to emulate severe, asynchronous errors that are traditionally very difficult to test. Of course, those skilled in the art will recognize that these are merely examples of the type of sequences that can be included, and that an error response test program can include more or less of these types of error creation code sequences.

The Watchdog timeout sequence forces the application under test into timeout situations. The watchdog timer, commonly implemented in software applications, watches for timeout situations where the application has failed to respond for a determined period of time. When the watchdog timer runs down to zero, a watchdog interrupt occurs. To evaluate the application's response to a watchdog interrupt, the Watchdog timeout sequence inserts an infinite loop into the software application. When the application is run through the modified code it is caught in the infinite loop and the watchdog timer expires and generates the interrupt. By inserting the watchdog timeout sequence into the application program, the application program's response to the interrupt can be monitored and evaluated.

The Unhandled software exception sequence forces the application under test to raise a software exception. In one implementation, the Unhandled software exception sequence emulates this type of error by performing a divide by zero operation. When the Unhandled software exception sequence is inserted in the application and run, response of the software exception at this execution path can be monitored and evaluated.

The Bus exception sequence forces the application under test into a bus exception. In one implementation, the Bus exception sequence emulates the bus exception error by forcing a reference to non-existent memory. When the modified application is forced to run through this sequence, a bus exception occurs and the error response test program can monitor the response of the test program.

The Unhandled interrupt sequence forces the application under test to service an interrupt that has no interrupt handler installed. Interrupt service routines are commonly installed to service various interrupts that are expected as part of the system architecture and design. A robust and reliable system should also be able to respond to an unexpected interrupt which has no service routine installed. One implementation of this error is accomplished by adding a software interrupt with no installed handler. By inserting an unhandled interrupt sequence into the application software, the application program's response to an unhandled interrupt can be monitored and evaluated.

The Uncorrectable EDAC error sequence forces the application under test into a multiple bit error condition. Critical computer systems often have an Error Detection and Correction (EDAC) circuit in the hardware to verify data integrity of the program code in memory. An uncorrectable EDAC error is an asynchronous error indicating that the integrity of the program code has been compromised. A robust and reliable system should respond to such an error. In one implementation, an uncorrectable EDAC error is emulated by changing EDAC check bits during operation. When the check bits are changed, the next read of the EDAC modified program code will cause an uncorrectable EDAC error. By inserting an uncorrectable EDAC error sequence into the application software, the application program's response to an uncorrectable EDAC error can be monitored and evaluated.

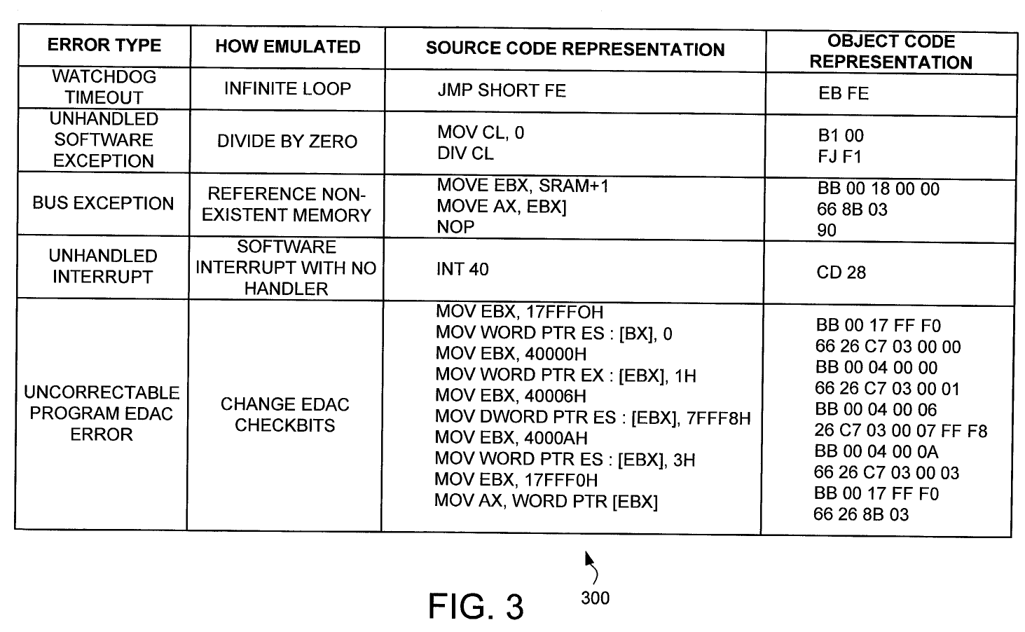

Turning now to FIG. 3, a table 300 illustrating several types of asynchronous error creating code sequences is provided. The table 300 includes rows for watchdog timeout errors, unhandled software exceptions, bus exceptions, unhandled interrupts and uncorrectable program EDAC errors. Table 300 gives an exemplary method for emulating each of these different types of errors, and shows both source and object code representations of exemplary error creating code sequences.

For example, the watchdog timeout error can be provided by injecting an infinite loop into the object code of the application software. Table 300 shows that a source code representation of such an error creating code sequence would be JMP SHORT FE. Such an infinite loop can be written into the application code by inserting an object code string EB FE into the desired location. Thus, during testing the error response test program inserts the EB FE string into the location of the application object code where the error is to be introduced. The modified application is then run and is caught in the infinite loop, causing the watchdog timer interrupt to activate. The application's response to the interrupt is monitored by the error response test system. The programmer can then determine if the application responded correctly. Note, since the injected error will cause the application to abandon its current control flow, the unmodified object code in the original application code sequence will not be executed. Thus, any functional change of that portion of the application caused by the introduction of the injected error is irrelevant.

Likewise, the other example code sequences are designed to introduce other asynchronous errors into the application program. Those skilled in the art will recognize that the source code representation and object code representation of the various code sequences are merely exemplary, and that they may be implemented in different ways depending upon the specific application.

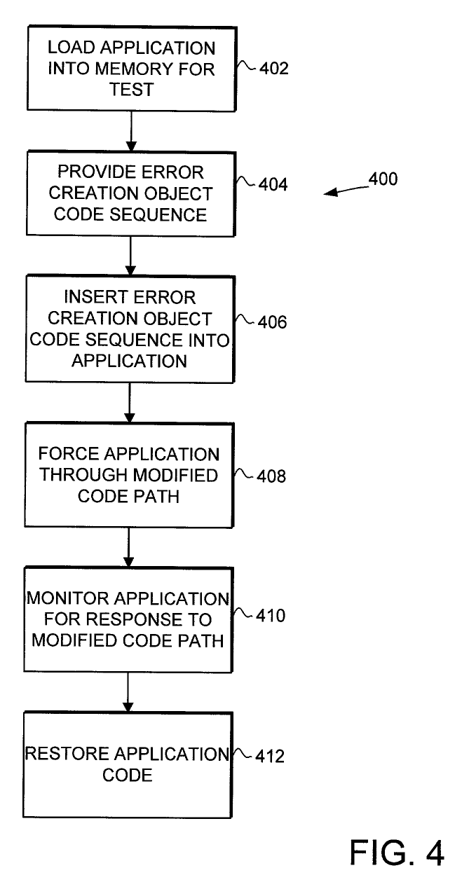

Turning now to FIG. 4, a method 400 of testing an application is illustrated. The test method 400 injects errors into the application under test by inserting error creation code sequences into the application. The application is then run and monitored for response to the inserted errors.

The first step 402 of method 400 is to load the application under test into memory. Loading the application under test into memory allows it to be executed. It also allows the loaded object code of the application under test to be modified for error testing.

During loading of the application under test, it is desirable to pinpoint specific locations in the loaded application that are to be tested. This facilitates the insertion of error creation code into the application at precise points. Specific memory address can be learned in a variety of ways. For example, the application under test can be written to register selected code addresses in a memory area that can be read by the error test system. That allows the error test system to locate precise locations in the application flow, and insert errors into those specific locations. Another way the error test system can learn the memory addresses is to hardcode them from a link map of the application under test.

The next step 404 is to provide an error creation object code sequence. The error creation code sequences can be generated at any time prior to use, although they would generally be done by programmers prior to the loading of the application software. The error creation code sequences can be created initially at the assembly source code level by the error test system developer. A temporary assembly source code module can then be created and assembled. The resulting object code bytes can then be manually examined by the error test system developer and parsed to make an object code sequence that is incorporated into the error test system. The error test system will then insert the error object code sequences directly into the loaded application program. Again, examples of the assembly code representation and final object code sequences were illustrated in FIG. 3.

The next step 406 is to insert the error creation code object code sequence into the loaded application program. At this step, it is desirable to insert the code sequences at specific locations in the application program. These locations can be provided when the application is loaded, as described above. The error creation code sequence can then be used to replace other code sequences in the application program. In some circumstances the original application code would be read and saved to allow the original code sequences to be restored at the completion of testing.

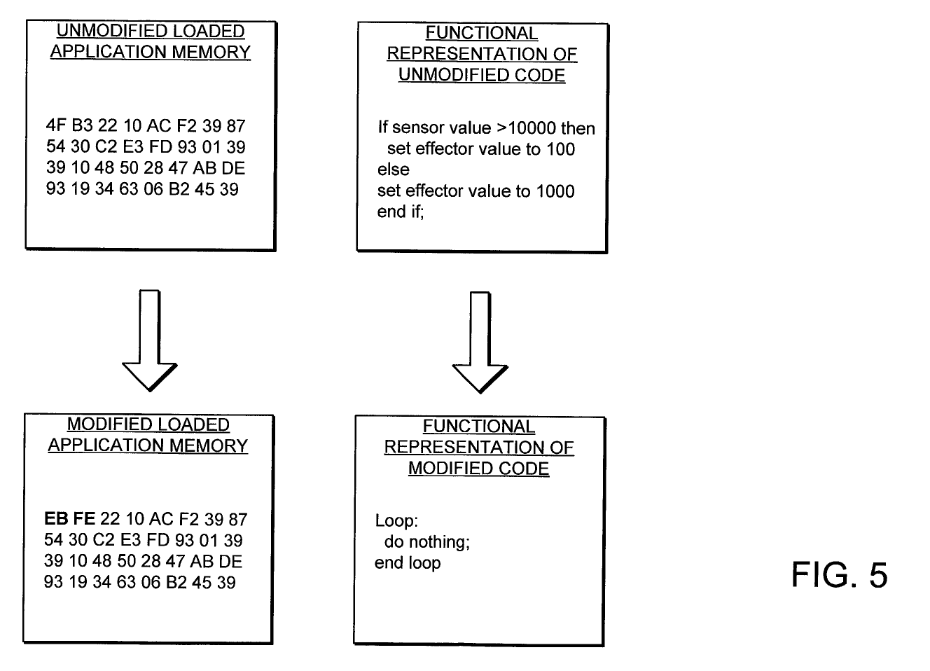

Turning now to FIG. 5, an exemplary portion of unmodified loaded application code is illustrated along with a functional representation of the unmodified code. The unmodified application code is a common if-then-else statement. During step 406, the unmodified code is replaced with an error creation code segment. FIG. 5 illustrates the exemplary portion of loaded application code after it has been modified, replacing the string 4F B3 with EB FE. As shown in the functional representation of the modified code, this insertion adds an infinite loop to the loaded application code. When run, this infinite loop will trigger a watchdog timeout, and the application's response to the watchdog timeout can be evaluated. Again, this is just one example of the types of error creation code sequences that can be added to the application for testing.

Returning to FIG. 4, the next step 408 is to force the application to run through the modified code path. This can be accomplished using any suitable code testing technique, such as the many common techniques used to test software. The next step 410 is then to monitor the application for response to the modified code path. In doing so, the application's response to the error created by the new code can be monitored and evaluated.

The next step 412 is to restore the original application code. This allows the program to again function normally, and allows further testing to proceed. This further testing can then include additional insertions of error creation code and testing of application response to these errors.

The present invention thus provides a system and method for testing an application program's response to severe, asynchronous errors. The error response test system provides the ability to test the response to asynchronous errors by inserting code sequences of application code that are desired to create an error in the application under test. The error response test system inserts the error creation code directly into the object of the application under test. The inserted error creation code causes an asynchronous error in the application under test at the specific point of insertion. The error creation code can be inserted in any location in the application under test. Thus, the application under test can be thoroughly tested for asynchronous error response. Additionally, the method and apparatus does not require the use of a special debugger or in-circuit emulator, and can instead be implemented entirely in software. Finally, the present invention can be implemented in a self-checking, automated and repeatable manner. This allows testing to be easily included as part of regularly executed test suites, and ensures that tests can be performed in real time.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. An apparatus comprising:
a) a processor;
b) a memory coupled to the processor;
c) an error response test program residing in the memory and being executed by the processor, the error response test program testing a loaded application program by inserting an error creation code sequence into the loaded application program, the error response test program executing the loaded application program while monitoring the loaded application program's response to an error resulting from the error creation code sequence.

2. The apparatus of claim 1 wherein the error resulting from the error creation code sequence comprises an asynchronous error.

3. The apparatus of claim 2 wherein the asynchronous error results in an interrupt delivered to the loaded application program.

4. The apparatus of claim 1 wherein the error creation code sequence comprises an object code sequence, and wherein the error response test program inserts the error creation code sequence into object code of the loaded application program.

5. The apparatus of claim 1 wherein the error response test program inserts the error creation code sequence into a portion of the loaded application program specified by the loaded application program during loading.

6. The apparatus of claim 1 wherein the error creation code sequence comprises an infinite loop sequence.

7. The apparatus of claim 1 wherein the error creation code sequence comprises a divide by zero sequence.

8. The apparatus of claim 1 wherein the error creation code sequence comprises a reference to non-existent memory sequence.

9. The apparatus of claim 1 wherein the error creation code sequence comprises a software interrupt with no installed handler sequence.

10. The apparatus of claim 1 wherein the error creation code sequence comprises a sequence to change EDAC checkbits.

11. A method for testing an application program, the method comprising the steps of:
a) loading the application program into memory;
b) inserting an error creation code sequence into the loaded application program;
c) executing the loaded application program with the error code sequence; and
d) monitoring a response of the loaded application program to an error resulting from the error creation code sequence.

12. The method of claim 11 wherein the error resulting from the error creation code sequence comprises an asynchronous error.

13. The method of claim 12 wherein the asynchronous error results in an interrupt delivered to the loaded application program.

14. The method of claim 11 wherein the inserted error creation code sequence comprises an object code sequence and wherein the step of inserting the error creation code sequence comprises inserting the error creation code object code into object code of the loaded application program.

15. The method of claim 11 further comprising the step of determining a location in the loaded application program for inserting the error creation code.

16. The method of claim 15 wherein the step of determining a location comprises registering the location during the step of loading the application program into memory.

17. The method of claim 11 wherein the error creation code sequence comprises an infinite loop sequence.

18. The method of claim 11 wherein the error creation code sequence comprises a divide by zero sequence.

19. The method of claim 11 wherein the error creation code sequence comprises a reference to a non existent memory sequence.

20. The method of claim 11 wherein the error creation code sequence comprises a software interrupt with no installed handler sequence.

21. The method of claim 11 wherein the error creation code sequence comprises a sequence to change EDAC checkbits.

22. A program product comprising:
a) an error response test program, the error response test program testing a loaded application program by inserting an error creation code sequence into the loaded application program, the error response test program executing the loaded application program while monitoring the loaded application program's response to an error resulting from the error creation code sequence; and
b) signal bearing media bearing said program.

23. The program product of claim 22 wherein said signal bearing media comprises recordable media.

24. The program product of claim 22 wherein said signal bearing media comprises transmission media.

25. The program product of claim 22 wherein the error resulting from the error creation code sequence comprises an asynchronous error.

26. The program product of claim 25 wherein the asynchronous error results in an interrupt delivered to the loaded application program.

27. The program product of claim 22 wherein the error creation code sequence comprises an object code sequence, and wherein the error response test program inserts the error creation code sequence into object code of the loaded application program.

28. The program product of claim 22 wherein the error response test program inserts the error creation code sequence into a portion of the loaded application program specified by the loaded application program during loading.

29. The program product of claim 22 wherein the error creation code sequence comprises an infinite loop sequence.

30. The program product of claim 22 wherein the error creation code sequence comprises a divide by zero sequence.

31. The program product of claim 22 wherein the error creation code sequence comprises a reference to non-existent memory sequence.

32. The program product of claim 22 wherein the error creation code sequence comprises a software interrupt with no installed handler sequence.

33. The program product of claim 22 wherein the error creation code sequence comprises a sequence to change EDAC checkbits.
